(19) United States
(12) Patent Application Publication
(10) Pub. No.: US 2026/0301354 A1
(43) Pub. Date: Oct. 1, 2026

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Ryosuke YONESAKA, Kanagawa (JP); Kazuhiko HORIKAWA, Kanagawa (JP); Fumito ITO, Kanagawa (JP); Yuichi ARAKI, Kanagawa (JP)

(73) Assignee: FUJIFILM Business Innovation Corp., Tokyo (JP)

(21) Appl. No.: 19/264,835

(22) Filed: Jul. 9, 2025

(30) Foreign Application Priority Data
Mar. 25, 2025 (JP) 2025-050040

(51) Int. Cl. G06V 10/141; B65H 3/48

(52) U.S. Cl. CPC G06V 10/141; B65H 3/48; B65H 2553/414

(57) ABSTRACT

An information processing system includes a processor configured to: cause a capturing section to capture a bundle of paper while adjusting entire light energy of light incident on the bundle of the paper stacked on a paper tray in which external light is not blocked; and control a flow rate of air based on a state of the paper floating in a case where the air is blown to a side surface of the bundle of the paper, the state being detected from a captured image of the bundle of the paper.

### CROSS-REFERENCE TO RELATED APPLICATIONS

This application is based on and claims priority under 35 USC 119 from Japanese Patent Application No. 2025-050040 filed Mar. 25, 2025.

### BACKGROUND

### (i) Technical Field

The present invention relates to an information processing system, a non-transitory computer readable medium storing a program, and an information processing method.

### (ii) Related Art

A technique is known in which air is blown to a bundle of paper stacked on a paper tray to float the paper so that an error such as double-feeding of the paper is suppressed. In such a technique, since the error suppression effect is different depending on the flow rate of air blown to the bundle of paper, a setting of the flow rate is required to improve the error suppression effect. JP2014-201413A discloses to calculate a distance between papers from a position of an edge portion of paper detected by a sensor, and set a flow rate such that the distance is appropriate.

### SUMMARY

However, since the sensor used for detecting the edge portion of the paper is based on the premise that the edge portion of the paper stacked on a paper tray in which the external light is blocked is detected, it may be difficult to detect the edge portion of the paper stacked on the paper tray in which the external light is not blocked.

Aspects of non-limiting embodiments of the present disclosure relate to an information processing system, a non-transitory computer readable medium storing a program, and an information processing method that makes it easier to detect an edge portion of paper stacked on a paper tray in which external light is not blocked, compared to a configuration in the related art based on the premise that the edge portion of the paper stacked on the paper tray in which the external light is blocked is detected.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: cause a capturing section to capture a bundle of paper while adjusting entire light energy of light incident on the bundle of the paper stacked on a paper tray in which external light is not blocked; and control a flow rate of air based on a state of the paper floating in a case where the air is blown to a side surface of the bundle of the paper, the state being detected from a captured image of the bundle of the paper.

### BRIEF DESCRIPTION OF THE DRAWINGS

Exemplary embodiment(s) of the present invention will be described in detail based on the following figures, wherein:

FIG. 1 is a diagram illustrating an example of an overall configuration of an information processing system to which the present exemplary embodiment is applied;

FIG. 2 is a diagram illustrating an example of a hardware configuration of an image processing apparatus configuring the information processing system of FIG. 1;

FIG. 3 is a diagram illustrating an example of a functional configuration of a control unit of the image processing apparatus;

FIG. 4 is a flowchart illustrating an example of a flow of a process of the image processing apparatus;

FIG. 5 is a diagram illustrating a specific example of a paper tray of FIG. 2;

FIGS. 6A to 6C are diagrams illustrating a state in a case where air is blown to a bundle of paper stacked on a paper tray;

FIG. 7 is a diagram illustrating a specific example of a paper tray in which external light is blocked; and

FIGS. 8A and 8B are graphs illustrating specific examples of a light energy adjustment process.

### DETAILED DESCRIPTION

Hereinafter, exemplary embodiments of the present invention will be described in detail with reference to the accompanying drawings.

### Configuration of Information Processing System 1

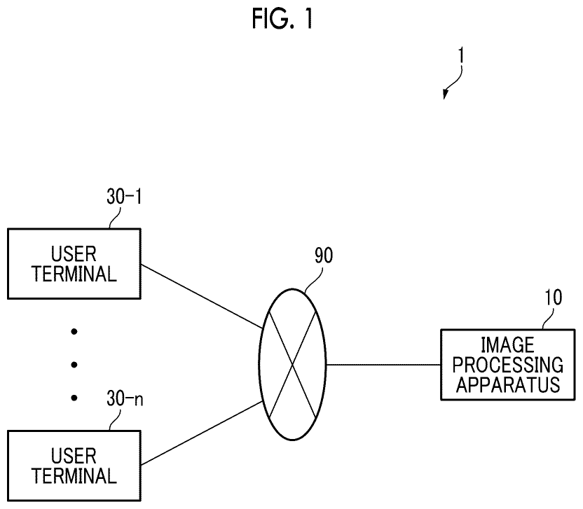

FIG. 1 is a diagram illustrating an example of an overall configuration of an information processing system 1 to which the present exemplary embodiment is applied.

The information processing system 1 is a system that can detect an edge portion of paper stacked on a paper tray of the image processing apparatus 10 in which external light is not blocked. Here, the “paper tray in which external light is not blocked” means a state in which external light is incident on the paper tray. The state in which the external light is incident on the paper tray is, for example, a case where the front cover of the image processing apparatus 10 is removed. The image processing apparatus 10 is in a state where the front cover is closed during normal printing, but may be forced to perform printing in a state where the front cover is open, for example, during maintenance. In such a case, external light may be incident on the paper tray, and it may be difficult to maintain the accuracy of the sensor that detects the edge portion of the paper. The information processing system 1 is a system that settles such problems.

The information processing system 1 is configured by connecting the image processing apparatus 10 and user terminals 30-1 to 30-n (n is an integer equal to or greater than 1) via a network 90. The network 90 is, for example, a local area network (LAN) or the Internet. Hereinafter, the user terminals 30-1 to 30-n will be collectively referred to as a “user terminal 30” unless necessary to be individually described.

### Image Processing Apparatus 10

The image processing apparatus 10 performs various types of processes according to an input operation of a user who uses the information processing system 1. For example, the image processing apparatus 10 can execute a printing process of forming and outputting an image on paper or the like as a recording medium, a copying process of copying and outputting an image of an original document on paper or the like, a reading process of reading an image formed on paper or the like, a process of transmitting an original document by a facsimile, and the like. The image processing apparatus 10 includes, for example, a so-called electrophotographic type multifunction machine that forms a toner image on a printing surface of paper and a so-called inkjet type printer that discharges ink onto a printing surface of paper.

The image processing apparatus 10 has an operation screen as a user interface, and can acquire input information input to the operation screen and execute various types of processes. In addition, the image processing apparatus 10 can acquire various types of information transmitted from the user terminal 30 connected to the image processing apparatus 10 via the network 90 and from the outside, and execute various types of processes. In addition, the image processing apparatus 10 can transmit various types of information to the user terminal 30 and the outside.

For example, the image processing apparatus 10 captures a state of paper floating in a case where air is blown to a side surface of a bundle of paper stacked on a paper tray, and detects an edge portion of the paper from the captured image (hereinafter, simply referred to as a “captured image”) to determine a floating state of the paper. Here, the “side surface of the bundle of paper” refers to a set of edge portions of each of the plurality of paper stacked on the paper tray. The image processing apparatus 10 can adjust the flow rate of the air blown to the side surface of the bundle of paper based on the determination result of the floating state of the paper.

The image processing apparatus 10 can capture a bundle of paper while adjusting the entire light energy of light incident on the bundle of paper stacked on the paper tray. Hereinafter, a process of adjusting the entire light energy of light incident on the bundle of paper stacked on the paper tray, which is performed by the image processing apparatus 10, will be referred to as a “light energy adjustment process”. Here, the “entire light energy of light incident on the bundle of paper” includes the light energy of illumination light irradiated from an irradiation section disposed in the paper tray toward the bundle of paper and the light energy of external light. The “external light” includes sunlight that is incident from the outside toward the image processing apparatus 10, light that is incident from a lighting fixture provided at a place where the image processing apparatus 10 is installed, and the like.

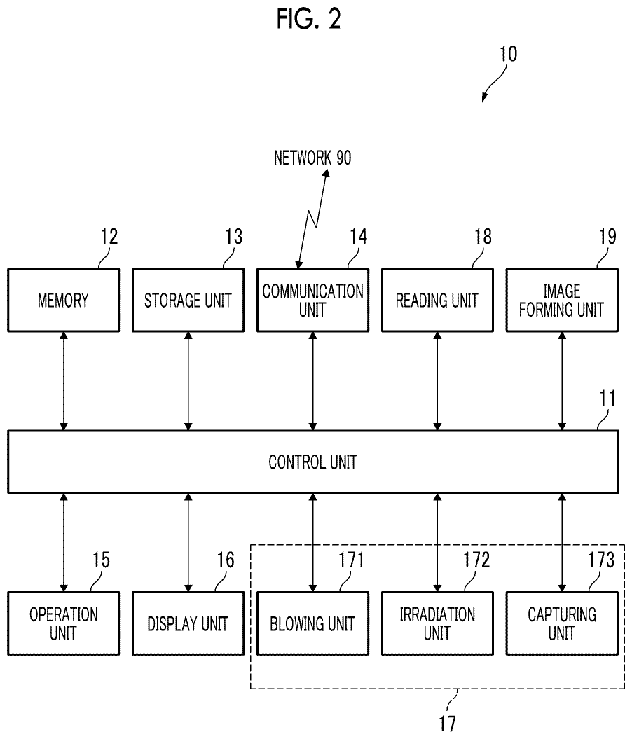

In the present exemplary embodiment, the entire light energy of the light incident on the bundle of paper includes at least one of the first light energy or the second light energy. The first light energy is perceived as light energy calculated from the intensity of external light and the exposure time of a capturing section disposed in the paper tray. The second light energy is perceived as light energy calculated from the intensity of illumination light from the irradiation section disposed in the paper tray and the exposure time of the capturing section disposed in the paper tray. The details of the capturing section and the irradiation section disposed in the paper tray will be described later with reference to FIG. 2.

The “exposure time” is a time (shutter speed) during which a shutter of the camera is open, and affects the brightness of the captured image. By increasing the exposure time, it is possible to take in a large amount of light energy, and thus the captured image becomes brighter. However, in a case where the exposure time is too long, the intensity of light to be taken in is too large, and overexposure occurs, the captured image becomes extremely bright, and “blown-out highlights” occur in which the highlight portion becomes completely white and the details are lost. In addition, in a case where the exposure time is too short, the amount of light energy to be taken in is insufficient, and underexposure occurs, the captured image becomes extremely dark, and “blackening” occurs in which the details of the shadow portion are lost. As a result, the subject (paper) included in the captured image is difficult to see.

The image processing apparatus 10 performs the light energy adjustment process using, for example, the following method. Specifically, the image processing apparatus 10 decides a combination of the intensity of the illumination light from the irradiation section and the exposure time such that the second light energy is greater than the first light energy. As a result, the light energy of the entire light incident on the bundle of paper is adjusted.

The image processing apparatus 10 that captures a bundle of paper stacked on the paper tray detects a state of paper that is floated by blowing air based on the captured image. Then, the image processing apparatus 10 controls the flow rate of the air blown to the bundle of paper based on the detected state of floating paper. The details of configuration and process of the image processing apparatus 10 will be described later.

### User Terminal 30

The user terminal 30 is an information processing apparatus such as a smartphone, a tablet terminal, or a personal computer operated by the user who uses the information processing system 1. The user terminal 30 is installed with application software that enables the generation of print data, the issuance of an instruction to execute the printing process or the like to the image processing apparatus 10 via the operation screen as the user interface.

The user terminal 30 can transmit various types of information to the image processing apparatus 10 and the outside. For example, the user terminal 30 can generate the print data based on the input operation of the user and transmit the print data to the image processing apparatus 10. For example, the user terminal 30 can transmit an instruction to execute the printing process or the like input on the operation screen to the image processing apparatus 10. In addition, the user terminal 30 can acquire various types of information transmitted from the image processing apparatus 10 and the outside, and execute various types of processes.

The above configuration of the information processing system 1 is merely an example, and the information processing system 1 as a whole may have functions that realize the above processing. Therefore, a part or all of the functions for realizing the process described above may be shared or cooperated in the information processing system 1. That is, a part or all of the functions of the image processing apparatus 10 configuring the information processing system 1 may be used as the functions of another information processing apparatus (for example, the user terminal 30). In addition, a part or all of the function of another information processing apparatus may be used as the function of the image processing apparatus 10. Further, a part or all of the functions of the image processing apparatus 10 or other apparatuses which configure the information processing system 1 may be transferred to another server (not illustrated). Accordingly, the processing of the information processing system 1 as a whole may be accelerated, and, in addition, the processing can also be complemented.

### Hardware Configuration

### Hardware Configuration of Image Processing Apparatus 10

FIG. 2 is a diagram illustrating an example of a hardware configuration of the image processing apparatus 10 configuring the information processing system 1 of FIG. 1.

The image processing apparatus 10 includes a control unit 11, a memory 12, a storage unit 13, a communication unit 14, an operation unit 15, a display unit 16, a paper tray 17, a reading unit 18, and an image forming unit 19. The above units are connected to each other via a data bus, an address bus, a Peripheral Component Interconnect (PCI) bus, or the like.

The control unit 11 is a processor that controls functions of the image processing apparatus 10 based on execution of various types of software such as an OS (basic software) and application software.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other.

The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The memory 12 is a storage region in which various types of software, pieces of data used for executing the software, or the like are stored, and is used as a work area in calculations. The memory 12 is configured of, for example, a random access memory (RAM).

The storage unit 13 is a storage region in which input data for various types of software, output data from various types of software, or the like are stored. The storage unit 13 is configured of, for example, a hard disk drive (HDD), a solid state drive (SSD), or a semiconductor memory, which is used for storing programs, various types of setting data, or the like. The storage unit 13 is provided with a database that stores various types of information.

The communication unit 14 transmits and receives data to and from the user terminal 30 and an outside via the network 90. The operation unit 15 is configured of, for example, a keyboard, a mouse, a mechanical button, or a switch, and receives an input operation.

The operation unit 15 also includes a touch sensor integrally configuring a touch panel with the display unit 16.

The display unit 16 is configured of, for example, a liquid crystal display or an organic electro luminescence (EL) display to be used for information display, and displays data of an image or a text and the like. The display unit 16 displays a user interface or the like.

The paper tray 17 is a mechanism that can stack and store paper to be used for printing, is disposed inside the image processing apparatus 10, or is disposed outside the image processing apparatus 10. The paper tray 17 corresponds to, for example, various paper sizes such as A4, A3, and letter size. The paper tray 17 includes a paper feeding tray (also referred to as an “input tray”), a paper discharge tray (also referred to as an “output tray”), a manual feed tray, and the like.

The paper feeding tray is a tray on which blank paper can be stacked before printing. In many cases, paper having different sizes and types are simultaneously stacked on each of the plurality of paper feeding trays. The paper discharge tray is a tray from which paper on which the printing is completed is discharged. The manual feed tray is an auxiliary tray used in a case of printing a small amount of special paper (for example, thick paper or an envelope). The paper tray 17 in the present exemplary embodiment is a paper feeding tray, and is configured to enable continuous printing by stacking several hundreds of sheets of paper.

The paper tray 17 includes a blowing unit 171 that blows air toward a side surface of a bundle of stacked paper, an irradiation unit 172 that irradiates the side surface of the bundle of stacked paper with illumination light as the irradiation section, and a capturing unit 173 that captures the side surface of the bundle of stacked paper as a capturing section. The blowing unit 171 blows air toward the side surface of the bundle of paper that is stacked to separate and float the paper one by one. Accordingly, the occurrence of a double-feeding error in which a plurality of sheets of paper are fed in a state in which the papers are stuck together is suppressed. The blowing unit 171 is particularly effective in a case where a large amount of printing is performed or in an environment in which the paper is likely to stick due to humidity. The blowing unit 171 is configured of, for example, a fan or an air duct disposed in the paper tray 17.

The irradiation unit 172 is configured of a light source such as a light emitting diode (LED), and irradiates the side surface of the bundle of the stacked paper with illumination light. As a result, the capturing by the capturing unit 173 which will be described later is assisted.

The capturing unit 173 is configured of a camera, an image sensor, an optical unit, or the like, and captures a side surface of a bundle of stacked paper. The camera is configured of, for example, a multi-wavelength spectroscopic camera. The multi-wavelength spectroscopic camera includes, for example, a hyperspectral camera, a multispectral camera, and a camera in which a color filter portion of an RGB camera is changed for a predetermined wavelength. In addition, the camera may be an infrared camera having a single wavelength.

The reading unit 18 reads an image recorded on a medium such as paper. The reading unit 18 may be configured of, for example, a Charge Coupled Devices (CCD) type scanner that reduces reflected light with respect to light emitted from a light source to an original document with a lens and receives the reflected light with a CCD. In addition, the reading unit 18 may be configured of a contact image sensor (CIS) type scanner or the like that receives reflected light with a CIS with respect to light emitted in order from an LED light source to an original document.

The image forming unit 19 forms an image to be printed on a printing surface of paper as a recording medium by, for example, an electrophotographic method, an inkjet method, or the like.

### Hardware Configuration of User Terminal 30

The user terminal 30 includes a control unit, a memory, a storage unit, a communication unit, an operation unit, and a display unit respectively corresponding to the control unit 11, the memory 12, the storage unit 13, the communication unit 14, the operation unit 15, and the display unit 16 illustrated in FIG. 2. These units are connected to each other via a data bus, an address bus, a PCI bus, or the like.

### Functional Configuration

### Functional Configuration of Image Processing Apparatus 10

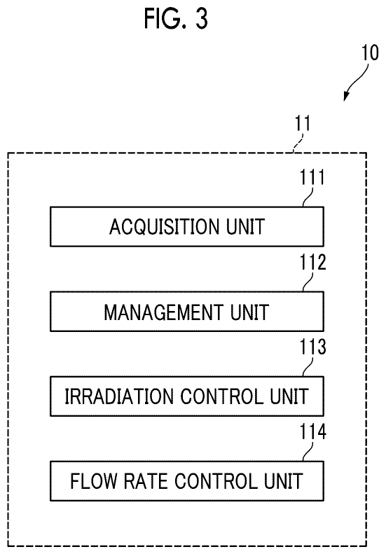

FIG. 3 is a diagram illustrating an example of a functional configuration of the control unit 11 of the image processing apparatus 10.

In the control unit 11 of the image processing apparatus 10, an acquisition unit 111, a management unit 112, an irradiation control unit 113, and a flow rate control unit 114 function.

The acquisition unit 111 acquires various types of information. For example, the acquisition unit 111 acquires the input information input to the operation screen displayed on the display unit 16 (see FIG. 2). In addition, the acquisition unit 111 acquires the input information input to the operation screen displayed on the user terminal 30. In addition, the acquisition unit 111 acquires setting information of the flow rate in which the blowing unit 171 (see FIG. 2) of the paper tray 17 blows air toward the bundle of paper. In addition, the acquisition unit 111 acquires the captured image captured by the capturing unit 173 (see FIG. 2) of the paper tray 17.

The management unit 112 stores and manages various types of information in the database of the storage unit 13 (see FIG. 2). For example, the management unit 112 stores and manages the captured image as the information representing the state of the floating paper, which is acquired by the acquisition unit 111, in the database.

The irradiation control unit 113 controls illumination light emitted from the irradiation unit 172 (refer to FIG. 2) of the paper tray 17. For example, the irradiation control unit 113 performs the light energy adjustment process by controlling the illumination light based on the information obtained from the captured image captured by the capturing unit 173. The irradiation control unit 113 decides a combination of the intensity of the illumination light and the exposure time such that the second light energy calculated from the intensity of illumination light and the exposure time is greater than the first light energy calculated from the intensity of external light and the exposure time, as the light energy adjustment process. In the light energy adjustment process, the irradiation control unit 113 decides the exposure time based on the intensity of external light and the intensity of illumination light.

In addition, the irradiation control unit 113 decides whether or not to perform the light energy adjustment process. For example, the irradiation control unit 113 decides whether or not to perform the light energy adjustment process based on the intensity of external light calculated from the captured image captured in a state where the illumination light is turned off. In this case, the irradiation control unit 113 may decide to perform the light energy adjustment process in a case where the intensity of external light calculated from the captured image is equal to or greater than a predetermined threshold value. In addition, the irradiation control unit 113 may decide whether or not to perform the light energy adjustment process according to the input operation of the user.

In addition, in the light energy adjustment process, the irradiation control unit 113 decides the intensity of illumination light and the exposure time based on the intensity of the external light calculated from the captured image captured in a state where the illumination light is turned off.

In addition, in a case where the magnitude of the second light energy with respect to the first light energy, is less than the predetermined threshold value, the irradiation control unit 113 can instantaneously increase the second light energy to be greater than the first light energy by emitting pulse light in accordance with the capturing. That is, for example, in a case where there is no margin in power for continuous irradiation, the irradiation control unit 113 can perform irradiation with a flashlight (strobe) that instantaneously emits strong light at a timing at which a camera shutter of the capturing unit 173 is cut.

The flow rate control unit 114 controls the flow rate of the air blown toward the bundle of paper by the blowing unit 171 based on the captured image acquired by the acquisition unit 111 and the setting information of the flow rate of the blowing unit 171 (see FIG. 2). Specifically, the flow rate control unit 114 detects a state of the floating paper from the captured image, and controls the flow rate based on the detection result and setting information of the flow rate. In addition, the flow rate control unit 114 can control the flow rate according to the input operation of the user.

### Flow of Process of Image Processing Apparatus 10

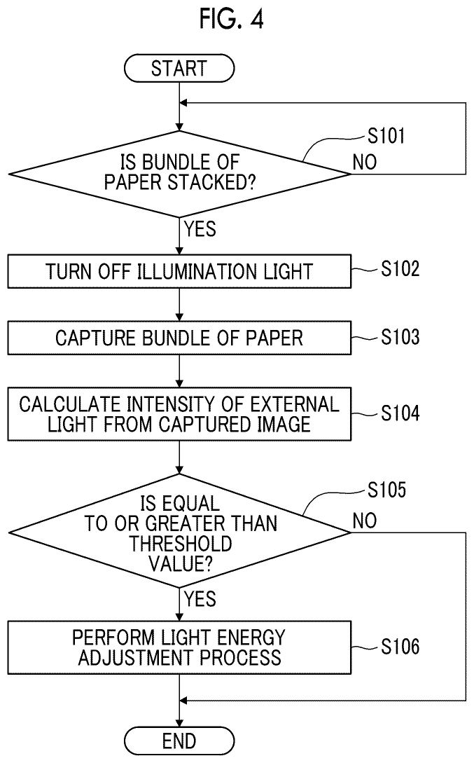

FIG. 4 is a flowchart illustrating an example of a flow of a process of the image processing apparatus 10.

In a case where a bundle of paper is stacked on the paper tray 17 (refer to FIG. 2, YES in step S101), the image processing apparatus 10 turns off the illumination light (step S102) and captures the bundle of paper (step S103). On the other hand, in a case where the bundle of paper is not stacked on the paper tray 17 (NO in step S101), the image processing apparatus 10 repeats a determination process in step S101.

The image processing apparatus 10 calculates the intensity of external light from the captured image captured in step S103 (step S104), and proceeds to a determination process in step S105. In a case where the intensity of external light is equal to or greater than the predetermined threshold value (YES in step S105), the image processing apparatus 10 determines a state where the external light is not blocked, performs the light energy adjustment process (step S106), and ends the processing (END). On the other hand, in a case where the intensity of external light does not satisfy the predetermined threshold value (NO in step S105), the image processing apparatus 10 determines a state where the external light is blocked, and ends the process without performing the light energy adjustment process (END).

### Specific Example

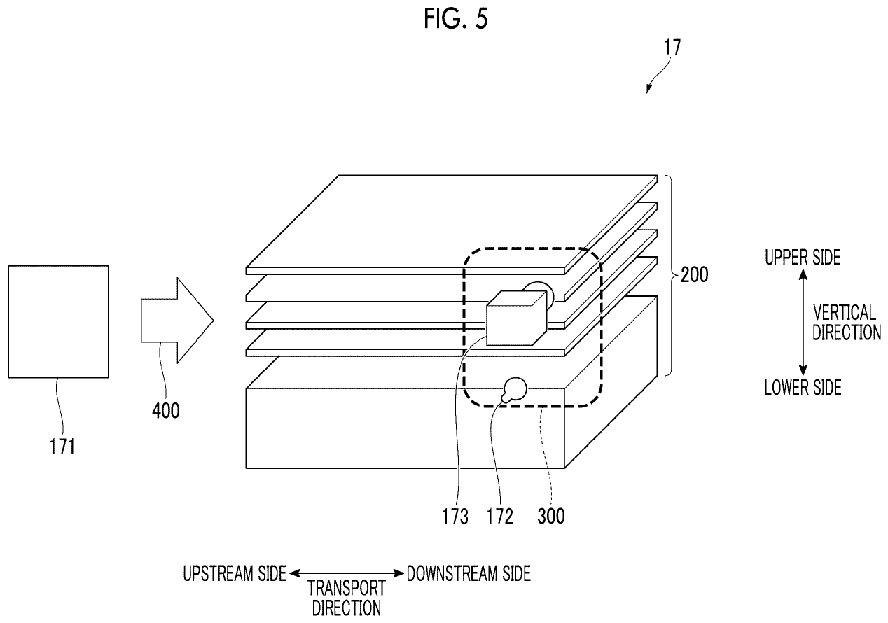

FIG. 5 is a diagram illustrating a specific example of the paper tray 17 in FIG. 2.

As illustrated in FIG. 5, the blowing unit 171 that blows air 400 toward the side surface of the bundle of the stacked paper 200 to float the paper 200 one by one is disposed in the paper tray 17. In addition, the irradiation unit 172 that irradiates the side surface of the bundle of paper 200 with illumination light and the capturing unit 173 that captures a capturing area 300 which is a part of the side surface of the bundle of paper 200 are disposed in the paper tray 17.

Hereinafter, a direction in which the paper 200 is transported is referred to as a “transport direction”. The paper 200 stacked on the paper tray 17 is transported toward the downstream side in the transport direction. In addition, a direction in which the paper 200 is floated by blowing air 400 toward the bundle of the paper 200 is referred to as a “vertical direction”. The paper 200 to which the air 400 is blown floats upper side in the vertical direction.

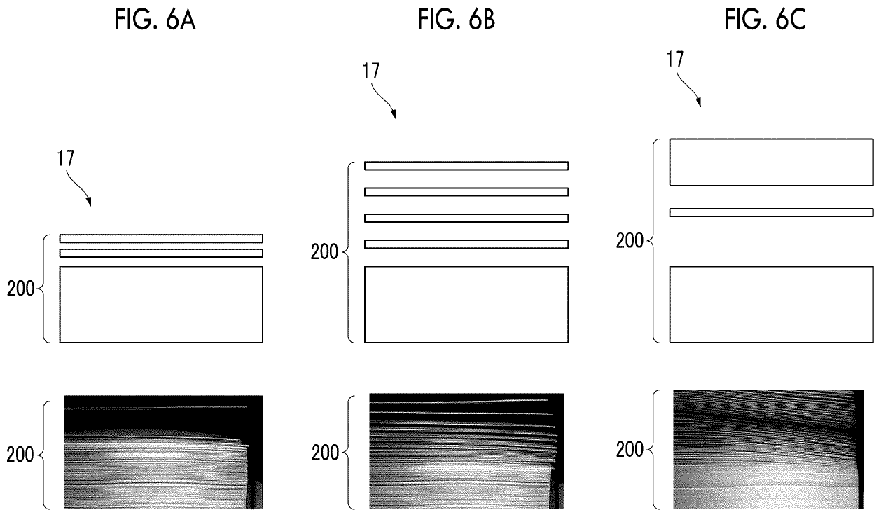

FIGS. 6A to 6C are diagrams illustrating a state in a case where air is blown to a bundle of paper 200 stacked on the paper tray 17.

FIG. 6A illustrates a schematic diagram (upper stage) and a captured image (lower stage) illustrating a state in a case where the flow rate of air blown to the bundle of paper 200 is insufficient. As illustrated in FIG. 6A, in a case where the flow rate of air blown to the bundle of paper 200 is insufficient, the desired amount (number of paper) of the paper 200 is not floated. In this case, the image processing apparatus 10 (see FIG. 1) performs a control of increasing the flow rate of air blown to the bundle of paper 200.

FIG. 6B illustrates a schematic diagram (upper stage) and a captured image (lower stage) illustrating a state in a case where the flow rate of air blown to the bundle of paper 200 is appropriate. As illustrated in FIG. 6B, for example, in a case where the flow rate of the air blown to the bundle of paper 200 is desired, the paper 200 in a desired amount are floated, and the floated paper 200 are separated one by one. In this case, the image processing apparatus 10 performs a control to hold the flow rate of air blown to the bundle of paper 200.

FIG. 6C illustrates a schematic diagram (upper stage) and a captured image (lower stage) illustrating a state in a case where the flow rate of air blown to the bundle of paper 200 is excessive. As illustrated in FIG. 6C, in a case where the flow rate of the air blown to the bundle of the paper 200 is excessive, a desired amount of the paper 200 floats, but the floated paper 200 is not separated one by one, and bias occurs. Therefore, the image processing apparatus 10 controls to reduce the flow rate of air blown to the bundle of the paper 200.

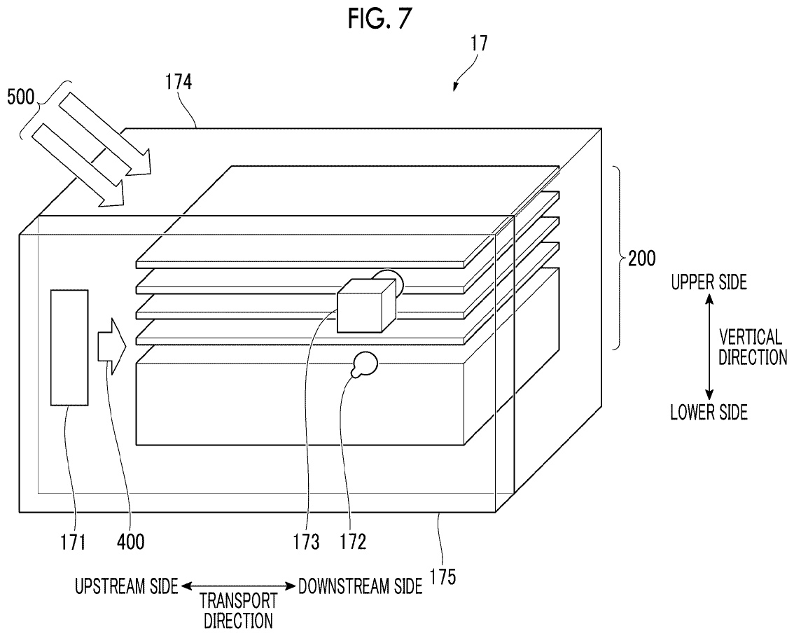

FIG. 7 is a diagram illustrating a specific example of the paper tray 17 in which the external light 500 is blocked.

As illustrated in FIG. 7, the paper tray 17 is configured to include a housing 174 having an inner space in which a bundle of paper 200 can be accommodated, and an openable and closable front cover 175. The blowing unit 171, the irradiation unit 172, and the capturing unit 173 are disposed in an inner space of the housing 174. The inner space of the housing 174 is a space in which the external light 500 is blocked in a case where the front cover 175 is closed, and is a space in which the external light 500 is not blocked in a case where the front cover 175 is opened.

As described above, the front cover 175 is closed in a case of normal printing in the paper tray 17. In this case, since the inner space of the housing 174 is almost in a dark state, the capturing unit 173 captures the bundle of the paper 200 using the illumination light emitted from the irradiation unit 172. However, for example, the front cover 175 is open during maintenance. In this case, since the external light 500 is incident on the inner space of the housing 174, the capturing unit 173 captures the bundle of the paper 200 using the external light 500 and the illumination light emitted from the irradiation unit 172.

In a case where the external light 500 is incident on the inner space of the housing 174, the inner space of the housing 174 may be brightened, or unnecessary rays may be incident on the camera of the capturing unit 173. In this case, the capturing unit 173 may not be able to clearly capture the floating paper, and it may be difficult to maintain the accuracy of detecting the edge portion of the paper. Therefore, the image processing apparatus 10 (see FIG. 1) performs the light energy adjustment process to maintain the accuracy of detecting the edge portion of the paper.

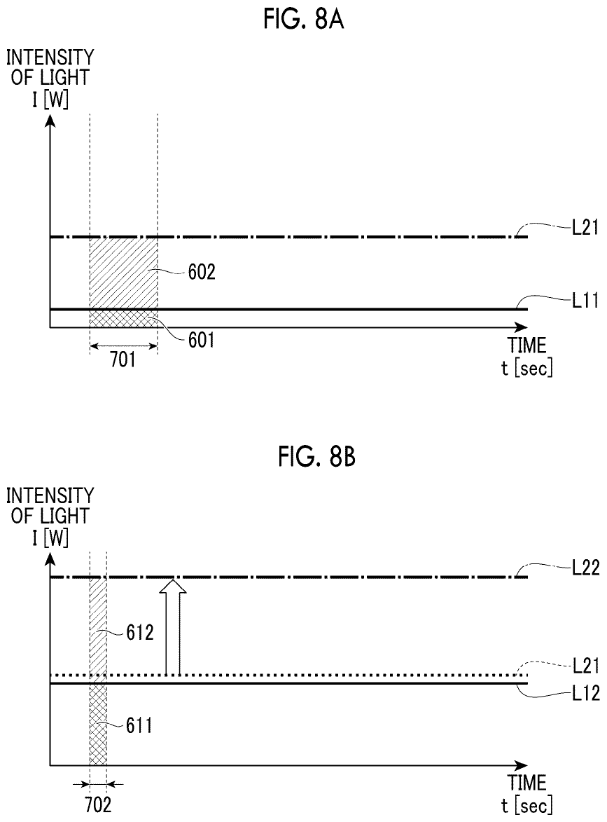

FIGS. 8A and 8B are graphs illustrating specific examples of the light energy adjustment process.

A graph of FIG. 8A illustrates a relationship between a time (t [sec]) and ab intensity of light (I [W]) in a case where printing is performed in a state where external light is blocked.

In a case where printing is performed in a state where external light is blocked, an inner space of the paper tray 17 (see FIG. 7) is almost in a dark state, and thus the bundle of the paper 200 is captured using the illumination light emitted from the irradiation unit 172 (see FIG. 7). In the graph of FIG. 8(A), the ambient light in the inner space of the paper tray 17 is represented by a solid line L11 indicating the intensity (I [W]) of the external light, and the intensity (I [W]) of the illumination light with which the irradiation unit 172 irradiates the edge portion of the bundle of paper is represented by a one-dot chain line L21.

Here, the exposure time when the bundle of the paper 200 is captured in a state where the external light is blocked is an exposure time 701 illustrated in FIG. 8A. In this case, the entire light energy of the light incident on the bundle of paper includes first light energy 601 and second light energy 602. The first light energy 601 is calculated from the intensity (I [W]) of the external light represented by a solid line L11 and the exposure time 701. In addition, the second light energy 602 is calculated from the intensity (I [W]) of illumination light represented by a one-dot chain line L21 and the exposure time 701.

In the graph of FIG. 8B, a relationship between a time (t [sec]) and an intensity of light (I [W]) in a case where printing is performed in a state where external light is not blocked is illustrated. In a case where printing is performed in a state where external light is not blocked, external light is incident on the inside of the paper tray 17, and a bundle of the paper 200 is captured using the external light and the illumination light emitted from the irradiation unit 172. In the graph of FIG. 8B, the ambient light in the inner space of the paper tray 17 is represented by a solid line L12 indicating the intensity (I [W]) of the external light, and the intensity (I [W]) of the illumination light with which the irradiation unit 172 irradiates the edge portion of the bundle of paper is represented by a one-dot chain line L22. That is, the total intensity of light (I [W]) in a state where the external light is not blocked is significantly increased as compared to the total intensity of light (I [W]) in a state where the external light is blocked. In this case, in a case where the exposure time is not changed, the intensity of light to be taken in is too large, and thus there is a concern that overexposure may occur.

Therefore, the exposure time when the bundle of the paper 200 is captured in a state where the external light is not blocked is controlled to be shorter than the exposure time when the bundle of the paper 200 is captured in the state where the external light is blocked. Therefore, the exposure time in a case where the bundle of the paper 200 is captured in a state where the external light is not blocked is exposure time 702 illustrated in FIG. 8B. In this case, the entire light energy of the light incident on the bundle of the paper includes first light energy 611 and second light energy 612. The first light energy 611 is calculated from the intensity (I [W]) of external light represented by the solid line L12 and the exposure time 702. In addition, the second light energy 612 is calculated from the intensity (I [W]) of illumination light represented by a one-dot chain line L22 and the exposure time 702.

In this case, a combination of the intensity (I [W]) of illumination light and the exposure time 702 is decided as follows. That is, the second light energy 612 calculated from the intensity (I [W]) of illumination light and the exposure time 702 is decided to be greater than the first light energy 611 calculated from the intensity (I [W]) of external light and the exposure time 702. Specifically, it is assumed that the intensity (I [W]) of external light is Iₑₙᵥ, the intensity (I [W]) of illumination light is Iₚₐₚₑᵣ, and the exposure time 702 is tₛₛ. In this case, the first light energy 611 is represented by Iₚₐₚₑᵣ×tₛₛ, the second light energy 612 is represented by Iₑₙᵥ×tₛₛ, and the pixel value of the captured image is represented by f((Iₚₐₚₑᵣ+Iₑₙᵥ)×tₛₛ). In this case, a combination of the intensity (I [W]) of illumination light and the exposure time 702 is decided such that Iₚₐₚₑᵣ>Iₑₙᵥ.

### Other Exemplary Embodiments

While the present exemplary embodiments have been described above, the present invention is not limited to the exemplary embodiments. In addition, effects of the present invention are not limited to the effects disclosed in the exemplary embodiments. For example, both the overall configuration of the information processing system 1 illustrated in FIG. 1 and the hardware configuration of the image processing apparatus 10 illustrated in FIG. 2 are merely examples for achieving the purpose of the present invention, and are not particularly limited.

In addition, the functional configuration of the image processing apparatus 10 illustrated in FIG. 3 is merely an example and is not particularly limited. As long as the information processing system 1 in FIG. 1 is provided with a function with which the above processing can be executed as a whole, a functional configuration to be used to implement the function is not limited to the example in FIG. 3. In addition, the order of the steps of the process of the image processing apparatus 10 illustrated in the flowchart of FIG. 4 is merely an example and is not particularly limited. Not only the processing is performed in time series along the illustrated order of the steps, but also the processing may not be performed in time series and may be parallelly or individually performed. In addition, the specific examples illustrated in FIG. 5 to FIG. 8 are merely an example and are not particularly limited.

In addition, in the above-described exemplary embodiment, the paper tray is described as the paper feeding tray, but the present invention is not limited thereto, and may be, for example, a paper discharge tray.

The present invention can also be applied to a program and a program product.

### Supplementary Note

(((1)))

An information processing system comprising:
a processor configured to:
   cause a capturing section to capture a bundle of paper while adjusting entire light energy of light incident on the bundle of the paper stacked on a paper tray in which external light is not blocked; and
   control a flow rate of air based on a state of the paper floating in a case where the air is blown to a side surface of the bundle of the paper, the state being detected from a captured image of the bundle of the paper.
      (((2)))

The information processing system according to (((1))),
wherein the entire light energy includes first light energy calculated from an intensity of the external light and exposure time of the capturing section, and second light energy calculated from an intensity of illumination light from an irradiation section and the exposure time, and
the processor is configured to perform adjustment of the entire light energy by deciding a combination of the intensity of the illumination light and the exposure time such that the second light energy is greater than the first light energy.
   (((3)))

The information processing system according to (((2))), wherein the processor is configured to:
decide the exposure time based on the intensity of the external light and the intensity of the illumination light.
   (((4)))

The information processing system according to (((2))) or (((3))), wherein the processor is configured to:
decide whether or not to perform adjustment of the entire light energy based on the intensity of the external light calculated from the captured image of the bundle of the paper captured in a state where the illumination light is turned off.
   (((5)))

The information processing system according to (((4))), wherein the processor is configured to:
decide to perform adjustment of the entire light energy in a case where the calculated intensity of the external light is equal to or greater than a predetermined threshold value.
   (((6)))

The information processing system according to (((5))), wherein the processor is configured to:
decide whether or not to perform adjustment of the entire light energy according to an input operation.
   (((7)))

The information processing system according to any one of (((2))) to (((6))), wherein the processor is configured to:
decide the intensity of the illumination light and the exposure time based on the intensity of the external light calculated from the captured image of the bundle of the paper captured in a state where the illumination light is turned off.
   (((8)))

The information processing system according to any one of (((2))) to (((7))), wherein the processor is configured to:
in a case where a magnitude of the second light energy with respect to the first light energy is less than a predetermined threshold value, increase the second light energy to be greater than the first light energy by emitting pulse light in accordance with capturing performed by the capturing section.
   (((9)))

A program executed by a computer that controls an image forming apparatus, the program causing the computer to realize:
a function of capturing a bundle of paper while adjusting entire light energy of light incident on the bundle of the paper stacked on a paper tray in which external light is not blocked; and
a function of controlling a flow rate of air based on a state of the paper floating in a case where the air is blown to a side surface of the bundle of the paper, the state being detected from a captured image of the bundle of the paper.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
cause a capturing section to capture a bundle of paper while adjusting entire light energy of light incident on the bundle of the paper stacked on a paper tray in which external light is not blocked; and
control a flow rate of air based on a state of the paper floating in a case where the air is blown to a side surface of the bundle of the paper, the state being detected from a captured image of the bundle of the paper.

2. The information processing system according to claim 1,
wherein the entire light energy includes first light energy calculated from an intensity of the external light and exposure time of the capturing section, and second light energy calculated from an intensity of illumination light from an irradiation section and the exposure time, and
the processor is configured to perform adjustment of the entire light energy by deciding a combination of the intensity of the illumination light and the exposure time such that the second light energy is greater than the first light energy.

3. The information processing system according to claim 2, wherein the processor is configured to:
decide the exposure time based on the intensity of the external light and the intensity of the illumination light.

4. The information processing system according to claim 2, wherein the processor is configured to:
decide whether or not to perform adjustment of the entire light energy based on the intensity of the external light calculated from the captured image of the bundle of the paper captured in a state where the illumination light is turned off.

5. The information processing system according to claim 4, wherein the processor is configured to:
decide to perform adjustment of the entire light energy in a case where the calculated intensity of the external light is equal to or greater than a predetermined threshold value.

6. The information processing system according to claim 5, wherein the processor is configured to:
decide whether or not to perform adjustment of the entire light energy according to an input operation.

7. The information processing system according to claim 2, wherein the processor is configured to:
decide the intensity of the illumination light and the exposure time based on the intensity of the external light calculated from the captured image of the bundle of the paper captured in a state where the illumination light is turned off.

8. The information processing system according to claim 2, wherein the processor is configured to:
in a case where a magnitude of the second light energy with respect to the first light energy is less than a predetermined threshold value, increase the second light energy to be greater than the first light energy by emitting pulse light in accordance with capturing performed by the capturing section.

9. A non-transitory computer readable medium storing a program executed by a computer that controls an image forming apparatus, the program causing the computer to realize:
a function of capturing a bundle of paper while adjusting entire light energy of light incident on the bundle of the paper stacked on a paper tray in which external light is not blocked; and
a function of controlling a flow rate of air based on a state of the paper floating in a case where the air is blown to a side surface of the bundle of the paper, the state being detected from a captured image of the bundle of the paper.

10. An information processing method comprising:
capturing a bundle of paper while adjusting entire light energy of light incident on the bundle of the paper stacked on a paper tray in which external light is not blocked; and
controlling a flow rate of air based on a state of the paper floating in a case where the air is blown to a side surface of the bundle of the paper, the state being detected from a captured image of the bundle of the paper.
